(19) United States
(12) Patent Application Publication
(10) Pub. No.: US 2018/0189143 A1
(43) Pub. Date: Jul. 5, 2018

(54) SIMULTANEOUS COMPRESSION OF MULTIPLE STORED VIDEOS

(71) Applicant: International Business Machines Corporation, Armonk, NY (US)

(72) Inventors: Vijay Kumar Ananthapur Bache, Bangalore (IN); Vijay Ekambaram, Tamilnadu (IN); Sarbajit K. Rakshit, Kolkata (IN); Saravanan Sadacharam, Chennai (IN)

(21) Appl. No.: 15/397,075

(22) Filed: Jan. 3, 2017

(51) Int. Cl. G06F 11/14; H04N 19/426; G06F 17/30

(52) U.S. Cl. CPC G06F 11/1451; G06F 2201/84; G06F 17/30091; H04N 19/426

(57) ABSTRACT

A method and associated systems for simultaneously compressing multiple stored videos. A file-backup system receives a set of uncompressed media files. The system divides the files into file clusters, each of which contains files that share common static-media metadata, such as a frame rate or resolution. For each file cluster, the frames of all files in the cluster are organized into a set of first-order frame clusters, each cluster containing frames that share common static-media metadata and common semantic metadata, such as a genre description. For each first-level frame cluster, the frames contained in that cluster are further divided into second-order frame clusters, each of which contains frames that share common static-media metadata, semantic metadata, and dynamic visual metadata, which describes in-frame entities, such as a texture or a background object. Each second-level cluster is then independently compressed and the results stored as one or more files.

### BACKGROUND

The present invention is related to methods of compressing digital media and, in particular, to a method of efficiently compressing multiple video files at the same time.

Digital-media files are often large enough to consume a significant amount of storage capacity and network bandwidth, so businesses often archive less frequently used multimedia to a secondary file-storage device to conserve resources. Archived files are stored in compressed form in order to save valuable storage capacity and reduce the time required to transfer archived content across a network. When delivered via a streaming-media platform, smaller, compressed files may also consume fewer network or system resources.

There is, however, often a trade-off between the size of a compressed file and the duration of time and amount of system resources required to compress the file. All things equal, compressing a file to a smaller size takes a longer duration of time and greater processor power.

In addition, known compression technologies are generally capable of compressing only one file at a time, ignoring possible efficiencies that might arise if it were possible to simultaneously compress multiple files.

There is thus a need for a method to more efficiently compress large digital-media files and to efficiently compress multiple files at the same time.

### BRIEF SUMMARY

One embodiment of the present invention provides a file-backup system comprising a processor, a memory coupled to the processor, a computer-readable file-storage device, and a local computer-readable hardware storage device coupled to the processor, the local computer-readable hardware storage device containing program code configured to be run by the processor via the memory to implement a method for simultaneous compression of multiple stored videos, the method comprising:
the processor retrieving a set of uncompressed video files from the file-storage device, where each retrieved file comprises a set of sequentially ordered frames, and where each retrieved file is characterized by a corresponding set of static video metadata and by a corresponding set of semantic metadata;
the processor associating each frame of each retrieved file with a set of semantic metadata and with a set of dynamic visual metadata;
the processor dividing the retrieved files into a set of file clusters, where all files of a first file cluster of the set of file clusters share common static video metadata;
the processor organizing the frames comprised by files of the first cluster into a set of first-level frame clusters, where all frames of a first frame cluster of the set of first-level clusters share common semantic metadata;
the processor further organizing the frames comprised by the first frame cluster into a set of second-level frame clusters, where all frames of a second frame cluster of the set of second-level frame clusters share common dynamic visual metadata; and
the processor compressing a sequence of video frames comprised by the second frame cluster into a compressed video file.

Another embodiment of the present invention provides a method for simultaneous compression of multiple stored videos, the method comprising:
a processor of a file-backup system retrieving a set of uncompressed video files from a file-storage device, where each retrieved file comprises a set of sequentially ordered frames, and where each retrieved file is characterized by a corresponding set of static video metadata;
the processor associating each frame of each retrieved file with a set of semantic metadata and with a set of dynamic visual metadata;
the processor dividing the retrieved files into a set of file clusters, where all files of a first file cluster of the set of file clusters share common static video metadata;
the processor organizing the frames comprised by files of the first cluster into a set of first-level frame clusters, where all frames of a first frame cluster of the set of first-level clusters share common semantic metadata;
the processor further organizing the frames comprised by the first frame cluster into a set of second-level frame clusters, where all frames of a second frame cluster of the set of second-level frame clusters share common dynamic visual metadata; and
the processor compressing a sequence of video frames comprised by the second frame cluster into a compressed video file.

Yet another embodiment of the present invention provides a computer program product, comprising a computer-readable hardware storage device having a computer-readable program code stored therein, the program code configured to be executed by a file-backup system comprising a processor, a memory coupled to the processor, a computer-readable file-storage device, and a local computer-readable hardware storage device coupled to the processor, the local computer-readable hardware storage device containing program code configured to be run by the processor via the memory to implement a method for simultaneous compression of multiple stored videos, the method comprising:
the processor retrieving a set of uncompressed video files from a file-storage device, where each retrieved file comprises a set of sequentially ordered frames, and where each retrieved file is characterized by a corresponding set of static video metadata;
the processor associating each frame of each retrieved file with a set of semantic metadata and with a set of dynamic visual metadata;
the processor dividing the retrieved files into a set of file clusters, where all files of a first file cluster of the set of file clusters share common static video metadata;
the processor organizing the frames comprised by files of the first cluster into a set of first-level frame clusters, where all frames of a first frame cluster of the set of first-level clusters share common semantic metadata;
the processor further organizing the frames comprised by the first frame cluster into a set of second-level frame clusters, where all frames of a second frame cluster of the set of second-level frame clusters share common dynamic visual metadata; and
the processor compressing a sequence of video frames comprised by the second frame cluster into a compressed video file.

### BRIEF DESCRIPTION OF THE DRAWINGS

FIG. 1 shows the structure of a computer system and computer program code that may be used to implement a method for simultaneous compression of multiple stored videos in accordance with embodiments of the present invention.

FIG. 2 is a flow chart that illustrates steps of a method for simultaneous compression of multiple stored videos in accordance with embodiments of the present invention.

FIG. 3A illustrates an example of how a method of FIG. 2 divides a set of video files into a set of file clusters as a function of static video metadata associated with each file.

FIG. 3B illustrates an example of how a method of FIG. 2 may reorganize frames comprised by files of a file cluster into a set of first-level frame clusters as a function of semantic metadata associated with each file of the file cluster.

FIG. 3C illustrates an example of how a method of FIG. 2 may reorganize frames comprised by a first-level frame cluster into a set of second-level frame clusters as a function of dynamic visual metadata associated with each frame of the first-level frame cluster.

### DETAILED DESCRIPTION

Embodiments of the present invention efficiently compress digital-media files by first organizing similar frames or similar samples of multiple digital files into frame or sample clusters, and then independently compressing each cluster and storing, streaming, or otherwise transferring the resulting content in compressed form.

When archiving or backing up large digital-media files, compression is often used to save storage space, and when transferring or delivering digital media, as in a streaming-media application, compression may be used to reduce network-bandwidth consumption. Although compression technologies vary considerably, many operate by detecting differences between adjacent frames or samples of a digital-media file, and then saving only those differences in the compressed output. In other words, redundant content that is comprised by adjacent frames is not wastefully stored multiple times.

When compressing a pair of adjacent frames, therefore, elements of the second frame that are identical to those of the first frame are not stored a second time when compressing the second frame. Instead, when compressing the second frame, a software link, address, pathname, object name, or other identifier is use to indicate that a previously stored element should be reproduced when decompressing the second frame.

One problem with currently known content-compression technologies is a trade-off between the duration of time required to compress a given media file and the file size of the resulting compressed file. In general, greater amounts of compression require greater computational power and longer processing times. In an environment where storage space, processor power, network bandwidth, or backup/archiving time are all limited resources, such a trade-off can be problematic when compressing a large digital-media library.

Most modern video-compression technologies use similar procedures to compress (or “encode”) a sequence of video frames. The first frame of the sequence may be encoded as a “keyframe”, “intra-coded picture”, or “I-frame”. Unlike other types of encoded frames, an encoded I-frame contains a copy of every element of its corresponding uncompressed frame. In other words, each I-frame of a compressed video file contains a fully specified compressed version of a static image and can be decompressed, without decompressing any adjacent compressed frames, in order to produce the original uncompressed frame.

Other frames of a video sequence may be encoded as “P-frames”, “delta frames”, or “predicted picture frames.” Each P-frame comprises only those elements of the corresponding uncompressed frame that are different than those of an immediately preceding frame. For example, if a video sequence displays a car moving across a static background, every visual element of the first frame might be encoded as an I-frame, but only the car's movements would need to be encoded in subsequent P-frames. P-frames may thus be compressed to much smaller sizes than I-frames.

Some video-compression mechanisms achieve even greater compression by also creating compressed “B-frames” or “bi-predictive picture” frames. Each B-frame expressly stores only those elements of a corresponding uncompressed frame that are different than elements of either an immediately preceding or an immediately following frame. In other words, a compressed B-frame stores only the differences between the corresponding uncompressed frame and the two frames adjacent to the corresponding uncompressed frame.

Embodiments and examples of the present invention may incorporate these known techniques of data compression, but in general, the present invention may transparently accommodate any other compression technology equally well.

Because encoding an I-frame requires greater storage space and processing power than does encoding a P-frame or a B-frame, decreasing the number of I-frames can both make a compression task faster and result in smaller compressed file sizes. But the total number of I-frames cannot be reduced below a number necessary to represent all uncompressed frames that differ greatly from adjacent frames.

Known methods of compression are generally capable of compressing only one file at a time, resulting in a compressed output file that contains a sequence of compressed frames in an order identical to that of frames in the original uncompressed input file. In such cases, the nature of content comprised by each uncompressed video file may set a lower limit on the size of a corresponding compressed file. Because a media file that contains a greater amount of changing content offers a compression technology fewer opportunities to discard identical frame-adjacent elements, such a file cannot in general be compressed to a size as small as would a file that contains more content that remains static from frame to frame.

Embodiments of the present invention address this issue by reorganizing frames or samples culled from multiple media files into a set of frame or sample clusters that each contains similar frames or samples. Because frames in a particular video cluster are more likely to depict similar visual elements, compressing that cluster may result in a smaller number of I-frames, making the resulting compression procedure faster and more efficient. Similarly, because samples in a particular audio cluster are more likely to have similar values, compressing that cluster may result in a smaller number of expressly stored samples, making the resulting compression procedure faster and more efficient.

These advantages are especially important when compressing a library of similar video or other media files. In a video-surveillance application, for example, it may be necessary to archive very large video files in order to create space for more current recordings. If each file is recorded by a camera that periodically sweeps across a shopping area, a conventional compression mechanism may find few pairs of adjacent frames that have identical visual elements. But there will nonetheless be many frames in each file that are substantially similar to those in other files. In such a case, regrouping the frames of all files into clusters of similar frames may allow each cluster to be compressed more efficiently than would be possible by compressing each file independently.

Similar efficiencies can be achieved when using an embodiment of the present invention to compress any other set of files that contain similar content. A season of television programming, for example, may be recorded as a set of video files that share common imagery or that are all shot on the same set. In such cases, where some frames of each file depict the same visual elements, regrouping similar frames prior to applying compression, may generate smaller compressed files in less time than would a conventional one-file-at-a-time compression procedure.

Embodiments of the present invention also offer the advantage of being able to process many video files concurrently or simultaneously. When implemented on a multi-processor system, such embodiments may thus be particularly well-suited to a parallel-processing platform, where parallel processors perform multiple compression tasks at the same time.

In some cases, an embodiment of the present invention may be applied to input files that have already been compressed by a different compression mechanism. Because of the present invention's different approach to setting up a compression task, such a second compression procedure may further reduce the size of the already compressed files.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

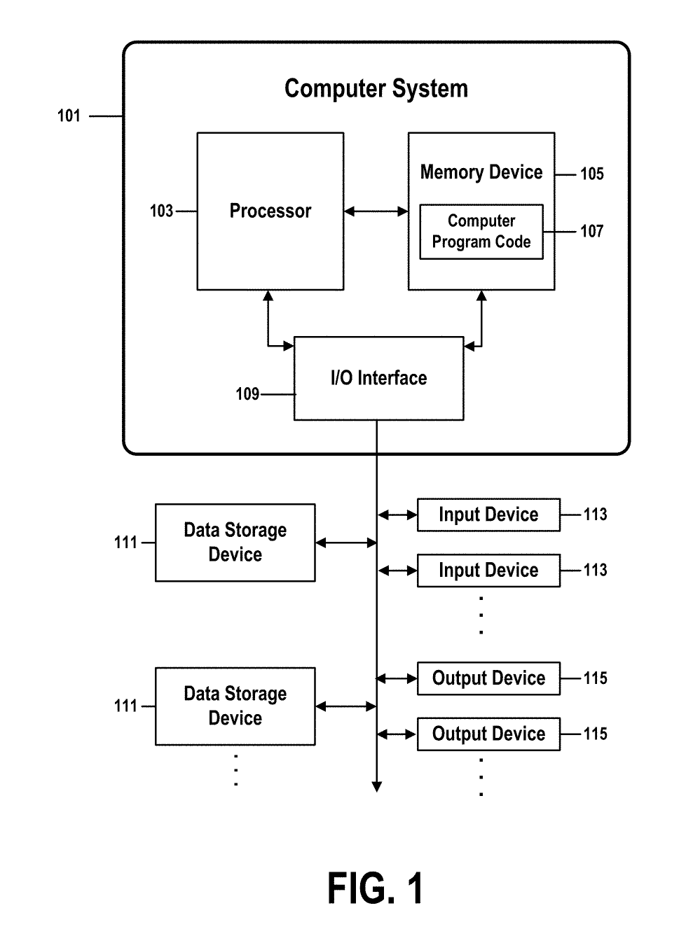

FIG. 1 shows a structure of a computer system and computer program code that may be used to implement a method for simultaneous compression of multiple stored videos in accordance with embodiments of the present invention. FIG. 1 refers to objects 101-115.

In FIG. 1, computer system 101 comprises a processor 103 coupled through one or more I/O Interfaces 109 to one or more hardware data storage devices 111 and one or more I/O devices 113 and 115.

Hardware data storage devices 111 may include, but are not limited to, magnetic tape drives, fixed or removable hard disks, optical discs, storage-equipped mobile devices, and solid-state random-access or read-only storage devices. I/O devices may comprise, but are not limited to: input devices 113, such as keyboards, scanners, handheld telecommunications devices, touch-sensitive displays, tablets, biometric readers, joysticks, trackballs, or computer mice; and output devices 115, which may comprise, but are not limited to printers, plotters, tablets, mobile telephones, displays, or sound-producing devices. Data storage devices 111, input devices 113, and output devices 115 may be located either locally or at remote sites from which they are connected to I/O Interface 109 through a network interface.

Processor 103 may also be connected to one or more memory devices 105, which may include, but are not limited to, Dynamic RAM (DRAM), Static RAM (SRAM), Programmable Read-Only Memory (PROM), Field-Programmable Gate Arrays (FPGA), Secure Digital memory cards, SIM cards, or other types of memory devices.

At least one memory device 105 contains stored computer program code 107, which is a computer program that comprises computer-executable instructions. The stored computer program code includes a program that implements a method for simultaneous compression of multiple stored videos in accordance with embodiments of the present invention, and may implement other embodiments described in this specification, including the methods illustrated in FIGS. 1-5. The data storage devices 111 may store the computer program code 107. Computer program code 107 stored in the storage devices 111 is configured to be executed by processor 103 via the memory devices 105. Processor 103 executes the stored computer program code 107.

In some embodiments, rather than being stored and accessed from a hard drive, optical disc or other writeable, rewriteable, or removable hardware data-storage device 111, stored computer program code 107 may be stored on a static, nonremovable, read-only storage medium such as a Read-Only Memory (ROM) device 105, or may be accessed by processor 103 directly from such a static, nonremovable, read-only medium 105. Similarly, in some embodiments, stored computer program code 107 may be stored as computer-readable firmware 105, or may be accessed by processor 103 directly from such firmware 105, rather than from a more dynamic or removable hardware data-storage device 111, such as a hard drive or optical disc.

Thus the present invention discloses a process for supporting computer infrastructure, integrating, hosting, maintaining, and deploying computer-readable code into the computer system 101, wherein the code in combination with the computer system 101 is capable of performing a method for simultaneous compression of multiple stored videos.

Any of the components of the present invention could be created, integrated, hosted, maintained, deployed, managed, serviced, supported, etc. by a service provider who offers to facilitate a method for simultaneous compression of multiple stored videos. Thus the present invention discloses a process for deploying or integrating computing infrastructure, comprising integrating computer-readable code into the computer system 101, wherein the code in combination with the computer system 101 is capable of performing a method for simultaneous compression of multiple stored videos.

One or more data storage units 111 (or one or more additional memory devices not shown in FIG. 1) may be used as a computer-readable hardware storage device having a computer-readable program embodied therein and/or having other data stored therein, wherein the computer-readable program comprises stored computer program code 107. Generally, a computer program product (or, alternatively, an article of manufacture) of computer system 101 may comprise the computer-readable hardware storage device.

While it is understood that program code 107 for a method for simultaneous compression of multiple stored videos may be deployed by manually loading the program code 107 directly into client, server, and proxy computers (not shown) by loading the program code 107 into a computer-readable storage medium (e.g., computer data storage device 111), program code 107 may also be automatically or semi-automatically deployed into computer system 101 by sending program code 107 to a central server (e.g., computer system 101) or to a group of central servers. Program code 107 may then be downloaded into client computers (not shown) that will execute program code 107.

Alternatively, program code 107 may be sent directly to the client computer via e-mail. Program code 107 may then either be detached to a directory on the client computer or loaded into a directory on the client computer by an e-mail option that selects a program that detaches program code 107 into the directory.

Another alternative is to send program code 107 directly to a directory on the client computer hard drive. If proxy servers are configured, the process selects the proxy server code, determines on which computers to place the proxy servers' code, transmits the proxy server code, and then installs the proxy server code on the proxy computer. Program code 107 is then transmitted to the proxy server and stored on the proxy server.

In one embodiment, program code 107 for a method for simultaneous compression of multiple stored videos is integrated into a client, server and network environment by providing for program code 107 to coexist with software applications (not shown), operating systems (not shown) and network operating systems software (not shown) and then installing program code 107 on the clients and servers in the environment where program code 107 will function.

The first step of the aforementioned integration of code included in program code 107 is to identify any software on the clients and servers, including the network operating system (not shown), where program code 107 will be deployed that are required by program code 107 or that work in conjunction with program code 107. This identified software includes the network operating system, where the network operating system comprises software that enhances a basic operating system by adding networking features. Next, the software applications and version numbers are identified and compared to a list of software applications and correct version numbers that have been tested to work with program code 107. A software application that is missing or that does not match a correct version number is upgraded to the correct version.

A program instruction that passes parameters from program code 107 to a software application is checked to ensure that the instruction's parameter list matches a parameter list required by the program code 107. Conversely, a parameter passed by the software application to program code 107 is checked to ensure that the parameter matches a parameter required by program code 107. The client and server operating systems, including the network operating systems, are identified and compared to a list of operating systems, version numbers, and network software programs that have been tested to work with program code 107. An operating system, version number, or network software program that does not match an entry of the list of tested operating systems and version numbers is upgraded to the listed level on the client computers and upgraded to the listed level on the server computers.

After ensuring that the software, where program code 107 is to be deployed, is at a correct version level that has been tested to work with program code 107, the integration is completed by installing program code 107 on the clients and servers.

Embodiments of the present invention may be implemented as a method performed by a processor of a computer system, as a computer program product, as a computer system, or as a processor-performed process or service for supporting computer infrastructure.

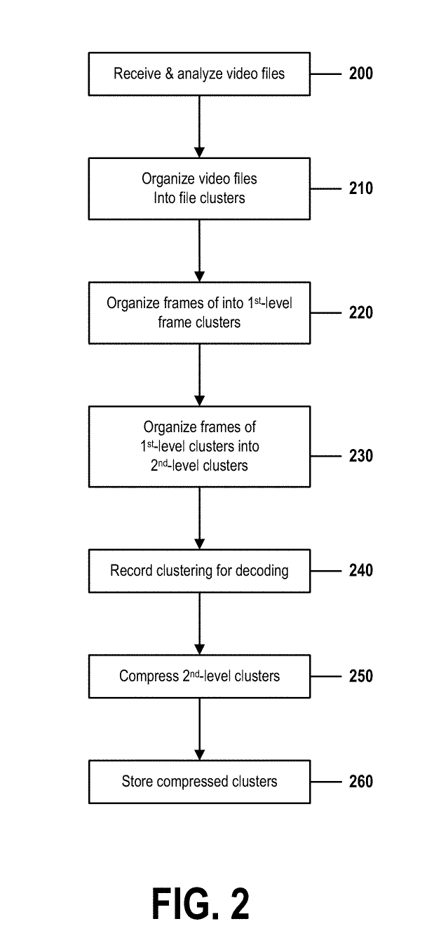

FIG. 2 is a flow chart that illustrates steps of a method for simultaneous compression of multiple stored videos in accordance with embodiments of the present invention. FIG. 2 comprises steps 200-260.

In step 200, a processor of a digital-media archiving system receives a set of media files to be compressed and archived. The digital-media archiving system may comprise any sort of hardware-based, software-based, or integrated hardware/software storage system, which may comprise a computer-readable file-storage device, such as a rotating-media hard drive, a writeable optical drive, a tape unit, a solid-state storage device, a RAID array or any other type of non-transitory storage medium that may be used to store media files that comprise a sequence of compressible frames, samples, or other snapshots of digital content.

The system may further comprise hardware and software components 101-115 of FIG. 1, where computer program code 107 is configured to be run by the processor via the memory to implement a method of the present invention for compressing and archiving or storing multiple digital-media files. In a most general case, the system includes communications interfaces or additional file-storage devices that allow the system to read, retrieve, or otherwise receive multiple digital-media files, and to store compressed versions of the received files on the one or more computer-readable file-storage devices.

In one example, these media files may be a set of uncompressed video files that each comprises an ordered sequence of still-image frames. Each file may, by means known in the art, be associated with one or more types of metadata. This associating may be accomplished by known means, such as by the metadata into a header of a file or by associating a file with metadata stored elsewhere, such as in a distinct descriptor file maintained by the digital-media archiving system, or by an operating system, storage system, or video-processing application.

This metadata may comprise static video metadata that identifies fixed physical characteristics of a file, such as frame rate, resolution, bit rate, refresh rate, or, in the case of audio files, characteristics like sample size, bit rate, and sample rate. In some cases, the processor may, after receiving a video file in this step, use known means to generate static video metadata through direct inspection of the video file. Unlike other types of metadata described in this document, static video metadata is a property of an entire video file and has the same value for all frames of that file. Static video metadata can thus be identified without performing an analysis of a file's individual frames.

Each frame of the received video files may also be characterized by semantic metadata that associates each frame with meaningful descriptions of its content. Examples of semantic metadata are MP3 tags or video descriptors that that identify a frame as depicting a particular actor, a type of automobile, a house, or a human face. Semantic metadata may be stored in other forms, as is known in the art.

In some embodiments, the processor may in this step generate dynamic visual metadata for each frame of each received video file. In other embodiments, including the examples of FIG. 2, this additional metadata may instead be generated in step 230.

In step 210, the processor reorganizes the received uncompressed files into a set of file clusters. Each cluster may contain one or more of the received uncompressed files that all share at least one identical or sufficiently similar element of static video metadata. One cluster, for example, may comprise all video files that may be characterized by a 30 fps frame rate or CIF resolution. Similarly, another cluster might comprise all received video files that may be characterized by a 24 fps frame rate, a 640×480 resolution, and a 1-Mbps bit rate.

The choice of which static metadata elements by which to organize received files into clusters is transparent to embodiments of the present invention, which may accommodate any static metadata parameters deemed appropriate by an implementer. An implementer may, for example, choose which metadata parameters to consider based on the implementer's expert knowledge, technical constraints, or business priorities, or may simply choose all types of metadata that are already automatically collected by an operating system or an existing video-processing application.

In some embodiments, such as those that comprise a smaller number of files characterized by a broad range of metadata values, an implementer may decide that better results are obtained by allowing files within the same cluster to share a range of metadata values, rather than a single value. In such cases, a file cluster will comprise files that contain similar values of at least one static video parameter. Choosing to use similar values, rather than precise matches, to sort files into clusters may be determined by an implementer using whatever criteria the implementer deems appropriate, and such choices are transparent to embodiments of the present invention

For example, when clustering a larger number video files that can assume one of only three possible resolutions, it might make sense to organize files into three clusters, each of which is associated with one of the three possible resolutions. But in an implementation where relatively few files can assume any of a large number of resolutions, each file cluster may comprise files that fall within a range of resolution values that an implementer deems likely to increase the average number of files in each cluster. In one example, a first file cluster might comprise files with resolutions below 640×480, a second file cluster might comprise files with resolutions ranging from 640×480 through 1024×768, and a third cluster might comprise files with resolutions greater than 1024×768.

In more sophisticated embodiments, an implementer may choose to use a known statistical or other data-clustering method, such as an agglomerative-clustering or linkage-clustering algorithm, to organize files into clusters and to select and associate centroid or cluster-specific metadata values with each cluster.

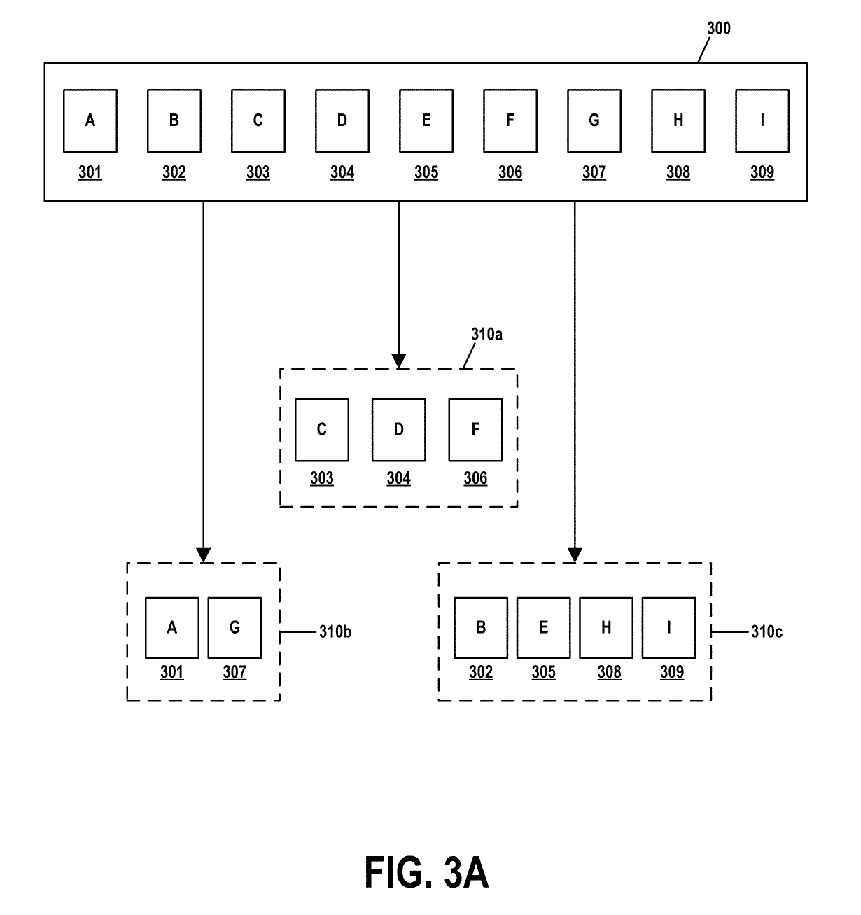

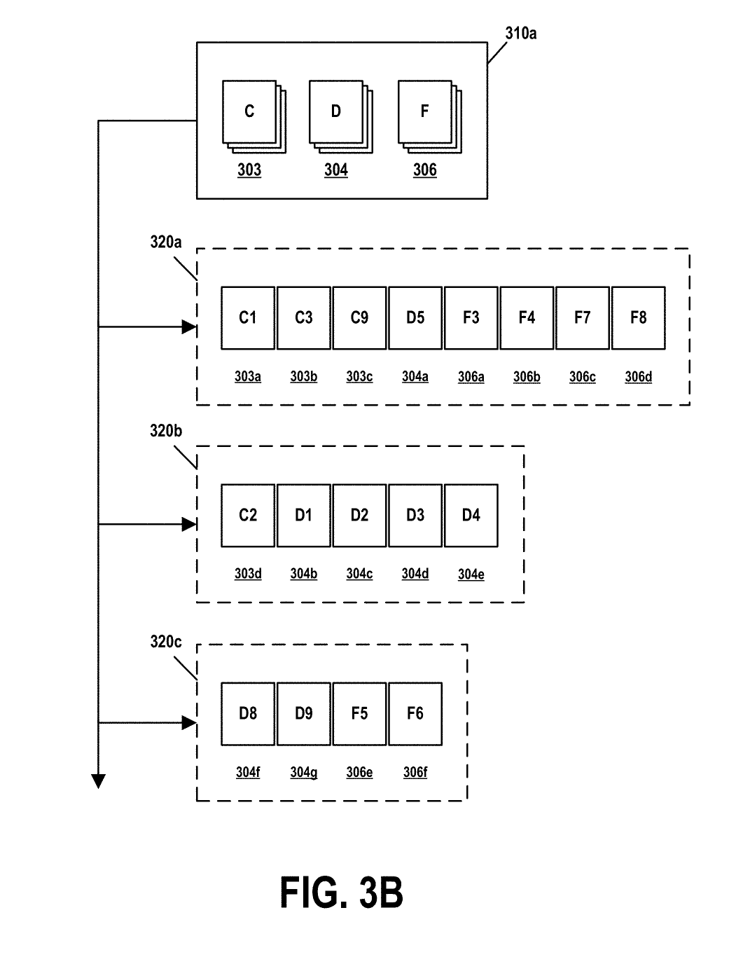

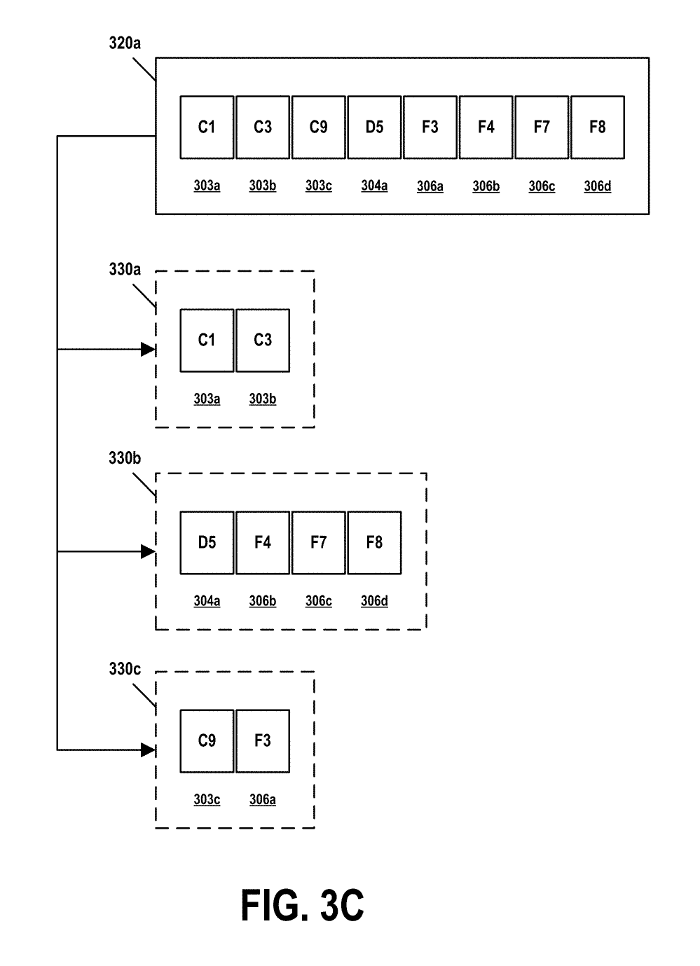

The result of a performance of step 210 is illustrated in FIG. 3A, which is described below in more detail. At the conclusion of step 210, the received files will have been organized into a set of file clusters, where each cluster comprises files that share common or similar values of static video metadata.

In step 220, the processor extracts the frames from each received file and distributes the extracted frames into sets of first-level frame clusters. This extraction may be performed by any means known in the art for processing multimedia digital content.

Each set of first-level frame clusters comprises in aggregate all frames extracted from all files of one corresponding file cluster. For example, if the processor in step 210 organized 1000 received files into 200 file clusters, then the processor in step 220 would create 200 sets of first-level frame clusters, one set for each the file clusters. Each frame cluster of a set of first-level frame clusters would comprise a subset of the frames comprised by files of its corresponding file cluster, and one full set of first-level frame clusters would, in aggregate, contain one instance of every frame culled from the frame-cluster set's corresponding file cluster.

Much like the files of each file cluster, all frames contained by a specific first-level frame cluster may be characterized by the same values, or by the same ranges of values, of one or more elements of semantic metadata. If semantic metadata did not accompany the uncompressed files received in step 200, the processor in this step may, by means known in the art, identify semantic metadata from extrinsic sources, such as an online media database or proprietary documentation provided by a content creator.

In one example, a first file cluster created in step 210 may comprise 40 received video files that each comprises NTSC-resolution color video shot at 30 fps. These 40 files may together comprise 100,000 frames, each of which is associated with this same resolution, color, and frame-rate metadata.

The processor in step 220 might organize these 100,000 frames into a set of 50 first-level frame clusters, where each cluster is each characterized by one or more common semantic-metadata values. One frame cluster, for example, might comprise all frames culled from video files that comprise NTSC-resolution color video shot at 30 fps and that are associated with semantic metadata indicating that the frame depicts a human hand. Another first-level frame cluster might similarly comprise all frames culled from video files that comprise NTSC-resolution color video shot at 30 fps and that are associated with semantic metadata indicating that the frame depicts a female face.

As in step 210, the selection of semantic metadata elements by which to organize frames into first-order frame clusters is transparent to embodiments of the present invention. An implementer may, for example, select metadata parameters by which to cluster frames based on expert knowledge, technical constraints, business priorities, or other factors, or may simply select what the implementer considers to be more relevant metadata from the set of available metadata automatically embedded into each file by an operating system. Embodiments of the present invention may accommodate any such choices.

In more sophisticated embodiments, a statistical or other data-clustering algorithm known in the art, such as an agglomerative-clustering or linkage-clustering algorithm, may be used to organize frames into first-order frame clusters and to select centroid values for semantic metadata parameters associated with each cluster.

The result of a performance of step 220 is illustrated in FIG. 3B, described below in more detail. At the conclusion of step 220, the system will have created one set of first-level frame clusters for each file cluster created in step 210. Each set of first-level frame clusters will comprise one instance of every frame comprised by a file of a corresponding file cluster, and every frame in the same first-level frame cluster will share common characteristics identified by semantic metadata and by static video metadata.

Similarly, in step 230, the processor reorganizes the frames comprised by each first-level frame cluster into a set of second-level frame clusters. In addition to sharing same or similar values of static video metadata and semantic metadata, frames comprised by any single second-level frame cluster share same or similar values (or values that fall into a same or similar range of values) of at least one type of dynamic visual metadata.

If no dynamic visual metadata is initially available for a frame, the processor will generate this metadata itself, using any means known in the art for analyzing still images, such as a type of pattern-matching pixel analysis. Such an analysis might, for example, produce dynamic visual metadata values that identify specific textures, color balances, contrast levels, color intensities, average brightness, or visual patterns comprised by a video frame or still image.

Each set of second-level frame clusters in aggregate comprises all frames of one corresponding first-level frame cluster. For example, if the processor in step 220 organized 1000 frames into 30 first-order frame clusters, then the processor in step 230 would create 30 sets of second-level frame clusters, each set corresponding to one of the first-order frame clusters. Each second-level frame cluster would comprise a subset of the frames of its corresponding first-level frame cluster, and one complete set of second-level frame clusters would, in aggregate, contain one instance of every frame comprised by the set's corresponding first-level frame cluster. Furthermore, all frames comprised by one second-level frame cluster will be associated with shared, common values of static-video metadata, semantic metadata, and dynamic visual metadata.

In one example, a first-level frame cluster created in step 220 may comprise 10,000 video frames all associated with static video metadata identifying HD resolution, a 60 fps frame rate, and an RGB color space, and with semantic metadata that specifies that the frame depicts a concert stage. These 10,000 frames may in step 230 then be further organized into 75 second-level frame clusters, each of which is associated with one distinct combination of color balance and average brightness and that each depicts a same background object.

One of these second-level frame clusters might, for example, comprise frames associated with HD-resolution, 60 fps RGB video and a “Documentary” genre and might depict a certain background set. Similarly, another second-level frame cluster might comprise frames associated with HD-resolution, 60 fps RGB video and a “Romantic Comedy” genre and might depict a background weather map.

As in steps 210 and 220, the choice of dynamic visual metadata elements by which to organize frames into second-order frame clusters is transparent to embodiments of the present invention. An implementer may, for example, select metadata parameters by which to cluster frames based on expert knowledge, technical constraints, business priorities, or other factors, or may expressly specify visual metadata elements that identifies objects known to commonly appear in the original received video files, such as a company logo. Embodiments of the present invention may accommodate any such choices.

As in steps 210 and 220, in more sophisticated embodiments, a statistical or other data-clustering algorithm known in the art, such as an agglomerative-clustering or linkage-clustering algorithm, may be used to organize frames into second-order frame clusters based on metadata values and to select centroid values for semantic metadata parameters associated with each cluster.

The result of a performance of step 230 is illustrated in FIG. 3C, which is described below in more detail. At the conclusion of step 230, the system will have created sets of second-level frame clusters, where each set of second-level clusters in aggregate comprise all frames extracted from one of the first-level clusters created in step 220. Each frame in the same second-level frame cluster will share common characteristics identified by a distinct and unique set of dynamic visual metadata, semantic metadata, and static video metadata values.

In step 240, if required, the processor compiles a record of the frames comprised by each second-level frame cluster. This record may identify each frame's original source file, original sequential position within the source file, and sequential position within its second-level cluster. This information may subsequently be used in a complementary procedure that decodes or decompresses the compressed content created in step 250 in order to restore the original uncompressed files.

This record-compilation may be performed by any means known in the art, such as by embedding metadata information into a file header or a frame header, storing the information in a distinct file (such as an .AAF file), storing the information in a container file (such as an .ASF or .AVI file), generating a log file of the results of some or all steps of FIG. 2, or by a combination of these and similar methods.

In a simple example, consider a second-level frame cluster that contains three frames: the 1025^{th} frame of original uncompressed video file “VF_001.YUV;” the 293^{nd} frame of original uncompressed video file “VF_427.YUV;” and the 12^{th} frame of an originally MPEG-compressed video file “Pres_VT_001.VOB.” When compressing this second-level cluster, the processor might concurrently produce a compression-log table that identifies a source location for each frame of the compressed file. This table may be formatted and stored in any manner known in the art, desired by an implementer, or compatible with the system's operating platform. For example, the information might be stored in a frame-reference table that comprises three entries for this three-frame second-level frame cluster:

| Position in cluster | Source | Position in source |
|---|---|---|
| 00:000:001 | VF_001.YUV | 00:000:1025 |
| 00:000:002 | VF_427.YUV | 00:000:0293 |
| 00:000:003 | Pres_VT_001.VOB | 00:000:0012 |

Many other methods of representing this information are possible. In some embodiments a position of a frame within an original source file may be identified by a time-code entry, rather than a sequential frame number. In other embodiments, all or part of the information in such a record may have been automatically tracked by an operating system, video-editing application, or other mechanism known in the art. In such cases, there may be no need for an embodiment to redundantly track the same information. In other cases, the system may initially tag each frame of each file received in step 200 with metadata that identifies the frame's source. This information would then accompany the frame as the frame is routed to a first-level cluster and a second-level cluster.

In some embodiments, these requirements may be alleviated if the steps 210-230 are performed without physically extracting frames from the files received in step 200. One example of such an embodiment occurs when the system creates a data structure that comprises links to every frame of every received file. In such cases, steps 210-230 may be performed by merely reorganizing those links. At the conclusion of step 230, the data structure would contain ordered sets of links that could then be used in step 250 to select, from the original files, frames to be included when compressing any of the second-level frame clusters.

In step 250, the processor compresses the content of each second-level frame cluster, treating each second-level cluster as a distinct, compressible sequence of frames. Because the frames in each second-level cluster share similar content, the compression of a sequence of frames comprised by a single second-level cluster may be a relatively high-efficiency, low-overhead procedure. When using a compression method capable of storing frames as P-frames or B-frames, each cluster may result in a higher ratio of B-frames or P-frames to higher-overhead I-frames.

This compression may be performed by any means known in the art and embodiments of the present invention may accommodate any such compression method. In some embodiments, the exact order of frames in a second-level cluster may not be important, so long as the frames are compressed and subsequently decoded in the same order.

In one example, the processor may compress the first frame of the cluster as an I-frame and then compress all following frames as “delta” P-frames. Unlike conventional compression tasks, where a processor must analyze each frame in order to identify which frames may most effectively be encoded as I-frames, such an analysis step may not be necessary because every frame in the cluster depicts content so similar to that of the other frames in the cluster that virtually any frame could have been selected as an I-frame. Arbitrarily selecting the first frame to be an I-frame and all subsequent frames to be P-frames may thus be a simple and efficient way to encode the entire cluster sequence.

In a more complex example, prior to compressing, the processor may perform a standard visual pixel analysis that, for each pixel, identifies the state of that pixel in each frame. This information may then be used to select an I-frame candidate that has a greatest number of pixels that are identical to pixels of other frames in the cluster. Such an embodiment would theoretically achieve faster compression and smaller output files, but would incur extra overhead by performing the pixel analysis.

Some embodiments may perform a standard compression procedure upon the cluster, such as an MPEG-4-compliant compression, or may perform some other compression algorithm known in the art. In either case, certain frames of the second-level frame cluster may be encoded as I-frames, P-frames, or bi-predictive B-frames.

In step 260, the processor stores the compressed content on one or more computer-readable storage media comprised by or available to the system, such as a rotating disk drive, an optical disc, or a solid-state storage device.

The compressed content of each second-level cluster may be stored as a distinct file. In some embodiments, the processor may combine compressed clusters into a smaller number of larger files or, if sufficient resources are available, all compressed clusters may be packed into a single compressed video file or container. Such mechanisms may be used in conjunction with a media-streaming application that decodes a streaming compressed file by means of a complementary decoding module at a target location that receives the streaming content. The present invention is thus flexible enough to accommodate any desired method of packaging and storing the compressed content.

Restoring the original content from the stored, compressed files requires a straightforward reversal of steps of FIG. 2. A processor of the digital-media archiving system or of a complementary system first reads the compressed content from the storage device on which it is stored. If necessary, it also reads additional information that identifies a source file and original frame position or time position of each frame stored in a compressed file.

The processor then decompresses each compressed file through known means, thus restoring the original uncompressed frames. If necessary, these frames are then reassembled into their original pre-compression order and stored, streamed, played, or otherwise accessed, saved, or processed, in their original, uncompressed form. At the conclusion of this decoding procedure, the system will have reconstituted the original uncompressed video files. Because the ratio of higher-overhead I-frames to lower-overhead P-frames or B-frames is lower than it would be in a conventional single-file compression procedure, this decompression procedure is likely to proceed more quickly than would a conventional decoding procedure performed on the same content.

FIG. 3A illustrates an example of how step 210 of a method of FIG. 2 may organize multiple video files into a set of file clusters as a function of static video metadata associated with each file. FIG. 3A comprises items 300-310c.

Item 300 is a set of source nine video files 301-309 received by the system in step 200 of FIG. 2. For clarity, each of these files has been labeled with a corresponding letter A-I. Item 301, for example, represents uncompressed video file “A.”

In this example, this initial set of video files may, by means the procedure of step 210, be divided into three video file clusters 310a, 310b, and 310c, each of which contains a subset of the files comprised by file set 300. Cluster 310a, for example, comprises files C 303, D 304, and F 306.

In aggregate, file clusters 310a-310c comprise one and only instance of every file 301-309 of initial file set 300, and all files that are associated with the same cluster may be characterized by the same or similar static video metadata. For example, files A 301 and G 307, both comprised by cluster 310b, may both be characterized by a 29.97 fps frame rate and 800×600 resolution. Files B 302, E 305, H 308, and I 309, all comprised by cluster 310c, might all be characterized by a 60 fps frame rate, a 24-bit color space, and a 1600×1200 resolution

FIG. 3B illustrates an example of how step 220 of a method of FIG. 2 may reorganize frames comprised by files of a file cluster into a set of first-level frame clusters as a function of semantic metadata associated with each file of the file cluster. FIG. 3B comprises items 303-320c.

Item 310a represents the same video-file cluster 310a of FIG. 3A and contains the same video files C 303, D 304, and F 306. As in FIG. 3B, each of these video files 303, 304, and 306 comprises a sequence of video frames. In this simple example, each frame is identified by the one-letter name of the file in which the frame is contained and by the frame's sequential frame position or time position within the file. The frames of file C 303 may thus be identified as C1, C2, C3, etc.

First-level frame clusters 320a, 320b, and 320c each comprise a subset of the total number of frames that make up files 303, 304, and 306. Cluster 320c, for example, comprises frame D8 304f and D9 304g (respectively, the 8^{th} and 9^{th} frames of file D 304), and frames F5 306e and F6 306f (the 5th and 6^{th} frames of file F 306). Similarly, first-level frame cluster 320a contains eight frames: the 1^{st}, 3^{rd}, and 9^{th} frames of file C 303 (C1 303a, C3 303b, and C9 303c), the 5^{th} frame of file D 304 (D5 304a) and the 3^{rd}, 4^{th}, 7^{th}, and 8^{th} frames of file F 306 (F3 306a, F4 306b, F7 306c, and F8 306d); and first-level frame cluster 320b contains the 2^{nd} frame of file C 303 (303d), and the first four frames of file D 304 (D1 304b, D2 304c, D3 304d, and D4 304e).

Many other frames comprised by the files 303-306 of video file cluster 310 may in a similar manner be organized into additional first-level frame clusters (not shown in FIG. 3B). As described in step 220, every frame comprised by a file cluster 310a must be comprised by one and only one cluster of a set of corresponding first-level frame clusters, such as the three frame clusters 320a-320c.

As further described in the description of FIG. 2, all frames of all first-level clusters 320a-320c are associated with the same static video metadata that is associated with files of corresponding parent file cluster 310a. In addition, each first-level frame cluster 320a-320c comprises frames that also share at least one common semantic metadata value. For example, the five frames in cluster 320b (303d and 304b-304e) may all be associated with a common bit rate, resolution, “science-fiction” genre, and frame rate (static video metadata) and may all be tagged with semantic metadata that indicates that the frames depict a red truck.

FIG. 3C illustrates an example of how step 230 of a method of FIG. 2 may reorganize frames comprised by a first-level frame cluster into a set of second-level frame clusters as a function of dynamic visual metadata associated with each frame of the first-level frame cluster. FIG. 3C comprises items 320a-330c.

Item 320a represents the same first-level frame cluster 320a of FIG. 3B and contains the same eight frames C1 303a, C3 303b, C9 303c, D5 304a, F3 306a, F4 306b, F7 306c, and F8 306d. In the example of FIG. 3B, each of these video files 303-306 is comprised of a sequence of video frames. In this simple example, each frame is identified by a name of the file in which the frame is contained and by the frame's frame position or time position within the file. The frames of file C 303 may thus be identified as C1, C2, C3, etc.

Second-level frame clusters 330a, 330b, and 330c each comprise a subset of the frames comprised by corresponding first-level frame cluster 320a. Second-level cluster 330a, for example, comprises frames C1 303a and C3 303b; second-level cluster 330b comprises frames D5 304a, F4 306b, F7 306c, and F8 306d; and second-level cluster 330c comprises frames C9 303c and F3 306a.

As described in the description of step 230, all frames of second-level clusters 330a-330c must share common static video metadata and semantic metadata with parent first-level cluster 320a, and every frame of first-level file cluster 320a must be comprised by one and only one second-level frame cluster 330a-330c. Furthermore, all frames in any one second-level cluster 330a, 330b, or 330c must be associated with the same dynamic visual metadata values. For example, like all frames of clusters 330a-330c, the two frames 303a and 303b of second-level cluster 330a may all share a common bit rate, resolution, genre, and frame rate (static video metadata) and may all depict the same class of objects (semantic metadata). In additional, all frames of second-level cluster 330a may be further associated with the same or similar visual metadata, such as the same ranges of average color temperatures and the same average brightness levels, and by the existence of a certain set of objects associated with a same fixed background.

What is claimed is:

1. A file-backup system comprising a processor, a memory coupled to the processor, a computer-readable file-storage device, and a local computer-readable hardware storage device coupled to the processor, the local computer-readable hardware storage device containing program code configured to be run by the processor via the memory to implement a method for simultaneous compression of multiple stored videos, the method comprising:
the processor retrieving a set of uncompressed video files from the file-storage device, where each retrieved file comprises a set of sequentially ordered frames, and where each retrieved file is characterized by a corresponding set of static video metadata;
the processor associating each frame of each retrieved file with a set of semantic metadata and with a set of dynamic visual metadata;
the processor dividing the retrieved files into a set of file clusters, where all files of a first file cluster of the set of file clusters share common static video metadata;
the processor organizing the frames comprised by files of the first cluster into a set of first-level frame clusters, where all frames of a first frame cluster of the set of first-level clusters share common semantic metadata;
the processor further organizing the frames comprised by the first frame cluster into a set of second-level frame clusters, where all frames of a second frame cluster of the set of second-level frame clusters share common dynamic visual metadata; and
the processor compressing a sequence of video frames comprised by the second frame cluster into a compressed video file.

2. The system of claim 1, further comprising:
the processor storing the compressed video file on the file-storage device.

3. The system of claim 1, where the static video metadata is capable of identifying at least one fixed physical characteristic of a video file.

4. The system of claim 1, where the semantic metadata is capable of identifying at least one semantically meaningful object comprised by a frame of a video file.

5. The system of claim 1, where the dynamic visual metadata is capable of identifying at least one pixel-related characteristic of a visual element comprised by a frame of a video file.

6. The system of claim 1, further comprising:
the processor repeating the organizing on all remaining file clusters of the set of file clusters, thereby generating a distinct set of first-level frame clusters for each file cluster of the all remaining file clusters;
the processor repeating the further organizing on each first-level frame cluster of the distinct sets of first-level frame clusters, thereby generating a distinct set of second-level frame clusters for each first-level frame cluster of the distinct sets of first-level frame clusters; and
the processor repeating the compressing for each second-level frame cluster of the distinct sets of second-level frame clusters.

7. The system of claim 6,
where every frame comprised by the retrieved files is comprised by only one second-level cluster of the distinct sets of second-level frame clusters.

8. A method for simultaneous compression of multiple stored videos, the method comprising:
a processor of a file-backup system retrieving a set of uncompressed video files from a file-storage device, where each retrieved file comprises a set of sequentially ordered frames, and where each retrieved file is characterized by a corresponding set of static video metadata;
the processor associating each frame of each retrieved file with a set of semantic metadata and with a set of dynamic visual metadata;
the processor dividing the retrieved files into a set of file clusters, where all files of a first file cluster of the set of file clusters share common static video metadata;
the processor organizing the frames comprised by files of the first cluster into a set of first-level frame clusters, where all frames of a first frame cluster of the set of first-level clusters share common semantic metadata;
the processor further organizing the frames comprised by the first frame cluster into a set of second-level frame clusters, where all frames of a second frame cluster of the set of second-level frame clusters share common dynamic visual metadata; and
the processor compressing a sequence of video frames comprised by the second frame cluster into a compressed video file.

9. The method of claim 8, further comprising:
the processor storing the compressed video file on the file-storage device.

10. The method of claim 8, where the static video metadata is capable of identifying at least one fixed physical characteristic of a video file.

11. The method of claim 8, where the semantic metadata is capable of identifying at least one semantically meaningful object comprised by a frame of a video file.

12. The method of claim 8, where the dynamic visual metadata is capable of identifying at least one pixel-related characteristic of a visual element comprised by a frame of a video file.

13. The method of claim 8, further comprising:
the processor repeating the organizing on all remaining file clusters of the set of file clusters, thereby generating a distinct set of first-level frame clusters for each file cluster of the all remaining file clusters;
the processor repeating the further organizing on each first-level frame cluster of the distinct sets of first-level frame clusters, thereby generating a distinct set of second-level frame clusters for each first-level frame cluster of the distinct sets of first-level frame clusters; and
the processor repeating the compressing for each second-level frame cluster of the distinct sets of second-level frame clusters,
where every frame comprised by the retrieved files is comprised by only one second-level cluster of the distinct sets of second-level frame clusters.

14. The method of claim 8, further comprising providing at least one support service for at least one of creating, integrating, hosting, maintaining, and deploying computer-readable program code in the computer system, wherein the computer-readable program code in combination with the computer system is configured to implement the retrieving, the associating, the dividing, the organizing, the further organizing, and the compressing.

15. A computer program product, comprising a computer-readable hardware storage device having a computer-readable program code stored therein, the program code configured to be executed by a file-backup system comprising a processor, a memory coupled to the processor, a computer-readable file-storage device, and a local computer-readable hardware storage device coupled to the processor, the local computer-readable hardware storage device containing program code configured to be run by the processor via the memory to implement a method for simultaneous compression of multiple stored videos, the method comprising:
the processor retrieving a set of uncompressed video files from a file-storage device, where each retrieved file comprises a set of sequentially ordered frames, and where each retrieved file is characterized by a corresponding set of static video metadata;
the processor associating each frame of each retrieved file with a set of semantic metadata and with a set of dynamic visual metadata;
the processor dividing the retrieved files into a set of file clusters, where all files of a first file cluster of the set of file clusters share common static video metadata;
the processor organizing the frames comprised by files of the first cluster into a set of first-level frame clusters, where all frames of a first frame cluster of the set of first-level clusters share common semantic metadata;
the processor further organizing the frames comprised by the first frame cluster into a set of second-level frame clusters, where all frames of a second frame cluster of the set of second-level frame clusters share common dynamic visual metadata; and
the processor compressing a sequence of video frames comprised by the second frame cluster into a compressed video file.

16. The computer program product of claim 15, further comprising:
the processor storing the compressed video file on the file-storage device.

17. The computer program product of claim 15, where the static video metadata is capable of identifying at least one fixed physical characteristic of a video file.

18. The computer program product of claim 15, where the semantic metadata is capable of identifying at least one semantically meaningful object comprised by a frame of a video file.

19. The computer program product of claim 15, where the dynamic visual metadata is capable of identifying at least one pixel-related characteristic of a visual element comprised by a frame of a video file.

20. The computer program product of claim 15, further comprising:
the processor repeating the organizing on all remaining file clusters of the set of file clusters, thereby generating a distinct set of first-level frame clusters for each file cluster of the all remaining file clusters;
the processor repeating the further organizing on each first-level frame cluster of the distinct sets of first-level frame clusters, thereby generating a distinct set of second-level frame clusters for each first-level frame cluster of the distinct sets of first-level frame clusters; and
the processor repeating the compressing for each second-level frame cluster of the distinct sets of second-level frame clusters,
where every frame comprised by the retrieved files is comprised by only one second-level cluster of the distinct sets of second-level frame clusters.
